(19) United States
(12) Patent Application Publication
(10) Pub. No.: US 2012/0033836 A1
(43) Pub. Date: Feb. 9, 2012

(54) SPEAKER AND ELECTRONIC DEVICE

(75) Inventor: Bill Yang, Taipei City (TW)

(73) Assignee: COTRON CORPORATION, Taipei City (TW)

(21) Appl. No.: 12/961,500

(22) Filed: Dec. 7, 2010

(30) Foreign Application Priority Data
Aug. 4, 2010 (TW) 99125947
Sep. 14, 2010 (TW) 99131049

(51) Int. Cl. H04R 1/00

(52) U.S. Cl. 381/191

(57) ABSTRACT

An electronic device and a speaker are provided. The speaker includes a housing, a magnet, a vibrating element, a circuit board and a electromagnetic inductor. The magnet is disposed in the housing. The vibrating element is disposed in the housing to vibrate relatively to the magnet for sounding. The electromagnetic inductor is disposed on the vibrating element for inducting a magnetic field of the magnet to generate electricity. The circuit board is disposed at the housing and has two audio input terminals, two audio output terminals, two power input terminals and two power output terminals. The audio input terminals are electrically connected to the audio output terminals, respectively. The power input terminals are electrically connected to the power output terminals, respectively. The vibrating element is electrically connected to the audio output terminals. The electromagnetic inductor is electrically connected to the power input terminals.

### CROSS-REFERENCE TO RELATED APPLICATION

This application claims the priority benefits of Taiwan application serial no. 99125947, filed on Aug. 4, 2010 and Taiwan application serial no. 99131049, filed on Sep. 14, 2010. The entirety of each of the above-mentioned patent applications is hereby incorporated by reference herein and made a part of specification.

### BACKGROUND

1. Field of the Invention

The invention relates to a speaker and an electronic device. Particularly, the invention relates to a speaker capable of generating electricity and an electronic device.

2. Description of Related Art

With continuous development of technology, electronic products are developed towards a trend of miniaturization, and people can use these miniaturized electronic products (for example, radios or walkmans, etc.) at any time and any place. Moreover, with a widespread of personal digital products, the products such as MP3 players, mobile phones, personal digital assistants (PDAs) and notebook computers, etc. become indispensable in people's daily life. Moreover, mobile phones integrating with functions of a radio and a MP3 are also developed.

Regardless of any of above electronic products, to ensure a user hearing sound information provided by the electronic product without interfering other people around, an earphone becomes a necessary accessory of the electronic product. Moreover, the earphone also provides a better sound transmission quality, so that the user can clearly hear the played sound unlike the unclear sound transmitted in the air, and especially during a movement period of the user, for example, sport, driving and intensive activity or in a noisy environment, the user can still clearly hear the sound without being influenced.

To drive the earphone for sounding, a wired earphone obtains electricity from a player through an earphone wire. However, since the player generally has a portable design, limited electricity therein has to be effectively used, namely, it is hard to provide additional electricity to the wired earphone to execute other functions. On the other hand, a wireless earphone uses electricity of an inbuilt battery to receive signals and send sounds. Similarly, limited electricity of the wireless earphone has to be effectively used, so that there is no extra electricity for executing other functions.

### SUMMARY OF THE INVENTION

The invention is directed to a speaker, which can resolve a problem of unable to execute additional functions due to inadequate electricity.

The invention is directed to an electronic device, in which a speaker can generate electricity to resolve a problem of inadequate electricity.

The invention provides a speaker including a housing, a magnet, a vibrating element, a circuit board and a electromagnetic inductor. The magnet is disposed in the housing. The vibrating element is disposed in the housing to vibrate relative to the magnet for sounding. The electromagnetic inductor is disposed on the vibrating element for inducting a magnetic field of the magnet to generate electricity. The circuit board is disposed at the housing and has two audio input terminals, two audio output terminals, two power input terminals and two power output terminals. The audio input terminals are electrically connected to the audio output terminals, respectively. The power input terminals are electrically connected to the power output terminals, respectively. The vibrating element is electrically connected to the audio output terminals. The electromagnetic inductor is electrically connected to the power input terminals.

In an embodiment of the invention, the vibrating element includes a diaphragm and a coil disposed on the diaphragm. The coil is electrically connected to the audio output terminals.

In an embodiment of the invention, the speaker further includes a power controller electrically connected to the electromagnetic inductor. Moreover, the speaker further includes a rechargeable battery, which is electrically connected to the electromagnetic inductor through the power controller for storing electricity generated by the electromagnetic inductor. Moreover, the power controller is electrically connected to the power input terminals, and the power output terminals are electrically connected to the rechargeable battery. Moreover, the power controller includes a rectifier and a battery charging chip, the electromagnetic inductor is electrically connected to the rectifier, the rectifier is electrically connected to the battery charging chip, and the battery charging chip is electrically connected to the rechargeable battery. The power controller is disposed on the circuit board, and the power input terminals are electrically connected to the power output terminals through the power controller.

The invention provides an electronic device including an audio generator and a speaker. The speaker includes a housing, a magnet, a vibrating element, a circuit board and a electromagnetic inductor. The magnet is disposed in the housing. The vibrating element is disposed in the housing to vibrate relative to the magnet for sounding. The electromagnetic inductor is disposed on the vibrating element for inducting a magnetic field of the magnet to generate electricity. The circuit board is disposed at the housing and has two audio input terminals, two audio output terminals, two power input terminals and two power output terminals. The audio input terminals are electrically connected to the audio output terminals, respectively. The power input terminals are electrically connected to the power output terminals, respectively. The vibrating element is electrically connected to the audio output terminals. The electromagnetic inductor is electrically connected to the power input terminals. The audio generator is electrically connected to the audio input terminals.

In an embodiment of the invention, the vibrating element includes a diaphragm and a coil disposed on the diaphragm. The coil is electrically connected to the audio output terminals.

In an embodiment of the invention, the electronic device further includes a power controller electrically connected to the electromagnetic inductor. Moreover, the electronic device further includes a rechargeable battery, which is electrically connected to the electromagnetic inductor through the power controller for storing electricity generated by the electromagnetic inductor. Moreover, the power controller is electrically connected to the power output terminals. Moreover, the power controller includes a rectifier and a battery charging chip, the electromagnetic inductor is electrically connected to the rectifier, the rectifier is electrically connected to the battery charging chip, and the battery charging chip is electrically connected to the rechargeable battery. The power controller is disposed on the circuit board, and the power input terminals are electrically connected to the power output terminals through the power controller.

According to the above descriptions, the electronic device and the speaker of the invention can execute additional functions by using electricity generated by the electromagnetic inductor.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a speaker according to an embodiment of the invention.

FIG. 2 is a front view of a circuit board of a speaker of FIG. 1.

FIG. 3 is a partial circuit block diagram of a speaker of FIG. 1.

FIG. 4 is a front view of a circuit board of a speaker of FIG. 1 according to another embodiment of the invention.

FIG. 5A and FIG. 5B are circuit diagrams illustrating two implementations of a power controller of FIG. 3.

FIG. 6 is a cross-sectional view of a speaker according to another embodiment of the invention.

FIG. 7 is a circuit block diagram illustrating an electronic device according to an embodiment of the invention.

### DETAILED DESCRIPTION OF DISCLOSED EMBODIMENTS

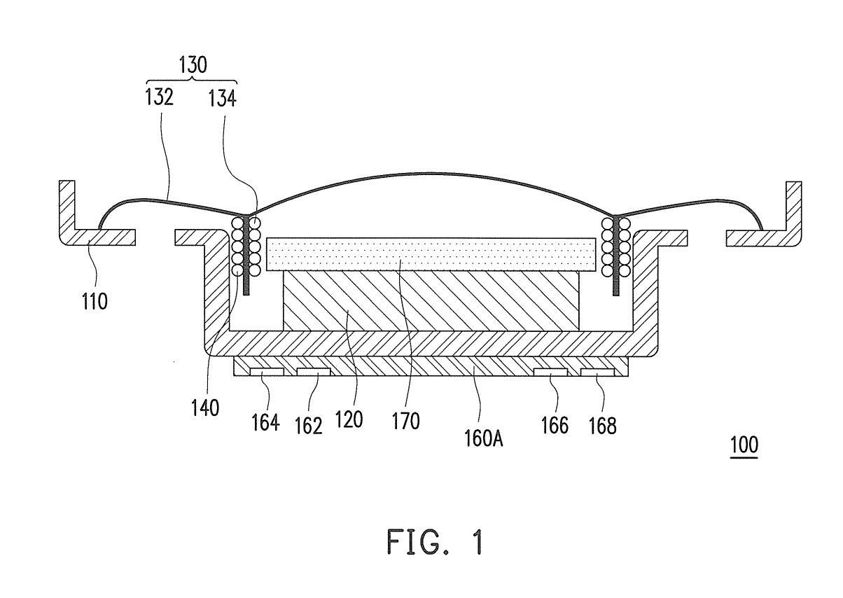

FIG. 1 is a cross-sectional view of a speaker according to an embodiment of the invention. Referring to FIG. 1, the speaker 100 of the present embodiment includes a housing 110, a magnet 120, a vibrating element 130 and a electromagnetic inductor 140. The magnet 120 is disposed in the housing 110. The vibrating element 130 is disposed in the housing 110 to vibrate relative to the magnet 120 for sounding. The electromagnetic inductor 140 is disposed on the vibrating element 130 for inducting a magnetic field of the magnet 120 to generate electricity. When the speaker 100 sounds, the vibration element 130 vibrates relative to the magnet 120, and drives the electromagnetic inductor 140 on the vibrating element 130 to vibrate relative to the magnet 120. The electromagnetic inductor 140 inducts strength and direction variations of the magnetic field of the magnet 120 during vibration, so as to generate electricity. In this way, although the speaker 100 consumes electricity for sounding, it can simultaneously generate electricity through the electromagnetic inductor 140. The electricity generated by the electromagnetic inductor 140 can be provided to the speaker 100 to execute additional functions, which meets a current environmental trend of carbon reduction. The speaker 100 of the present embodiment may not only be applied to earphones, but may also serve as a speaker of hi-fi equipment or other types of speakers.

The vibrating element 130 includes a diaphragm 132 and a coil 134 disposed on the diaphragm 132. When the coil 134 produces a magnetic field variation due to variation of an input electric signal, the magnetic field of the coil 134 interacts with the magnetic field of the magnet 120 to cause a movement of the coil 134, so as to drive the diaphragm 132 to vibrate for sounding. However, in other embodiments, the vibrating element 130 may be other types, and as long as the electromagnetic inductor 140 on the vibrating element 130 can be driven to vibrate relative to the magnet 120, the electromagnetic inductor 140 may generate electricity.

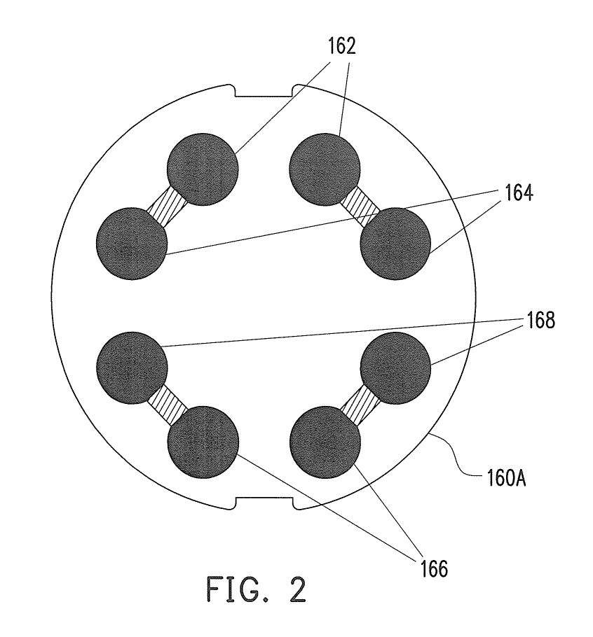

FIG. 2 is a front view of a circuit board of the speaker of FIG. 1. Referring to FIG. 1 and FIG. 2, the speaker 100 further includes a circuit board 160A disposed at the housing 110. The circuit board 160A has two audio output terminals 162, two audio input terminals 164, two power input terminals 166 and two power output terminals 168, and only a part of the terminals is illustrated in FIG. 1. Each of the audio input terminals 164 is electrically connected to one of the audio output terminals 162. Each of the power input terminals 166 is electrically connected to one of the power output terminals 168. The vibrating element 130 is electrically connected to the audio output terminals 162. In the present embodiment, the audio output terminals 162 are electrically connected to two ends of the coil 134 of the vibrating element 130 for transmitting sound source signals to the coil 134. The electromagnetic inductor 140 is electrically connected to the power input terminals 166, directly or indirectly, so that an inducting current of the electromagnetic inductor 140 can be output through the power output terminals 168. Moreover, in the present embodiment, the audio output terminals 162, the audio input terminals 164, the power input terminals 166 and the power output terminals 168 are, for example, located on a same surface of the circuit board 160A, though these terminals may also located on different surfaces of the circuit board 160A.

In the present embodiment, the electromagnetic inductor 140 is a coil, though in other embodiments, different types of the electromagnetic inductors can also be used. Moreover, in the present embodiment, the speaker 100 further includes a yoke 170 disposed on the magnet 120. In the present embodiment, the electromagnetic inductor 140 inducts the magnetic field of the magnet 120 to generate electricity.

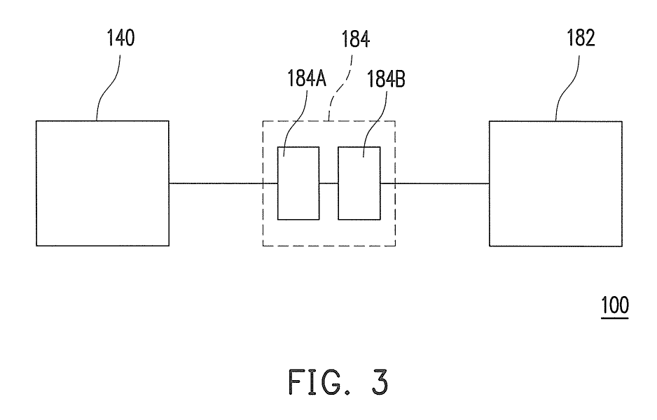

FIG. 3 is a partial circuit block diagram of the speaker of FIG. 1. Referring to FIG. 1 and FIG. 3, the speaker 100 may further include a rechargeable battery 182, which is directly or indirectly connected to the electromagnetic inductor 140 for storing electricity generated by the electromagnetic inductor 140. In other words, the rechargeable battery 182 can store the electricity generated by the electromagnetic inductor 140, and such electricity can be used for sounding, wireless signal receiving or other utilizations. Moreover, the speaker 100 of the present embodiment may further include a power controller 184, which is electrically connected between the rechargeable battery 182 and the electromagnetic inductor 140 to ensure that the electricity generated by the electromagnetic inductor 140 can be suitably stored. The rechargeable battery 182 and the power controller 184 can be disposed inside or outside the housing 110. The speaker 100 may only include the power controller 184 without the rechargeable battery 182.

Referring to FIG. 2 and FIG. 3, the electromagnetic inductor 140 can be electrically connected to the power input terminals 166 of the circuit board 160A, the power output terminals 168 are electrically connected to the power controller 184, and the power controller 184 is electrically connected to the rechargeable battery 182. Alternatively, the electromagnetic inductor 140 can be electrically connected to the power controller 184, the power controller 184 is electrically connected to the power input terminals 166 of the circuit board 160A, and the power output terminals 168 are electrically connected to the rechargeable battery 182.

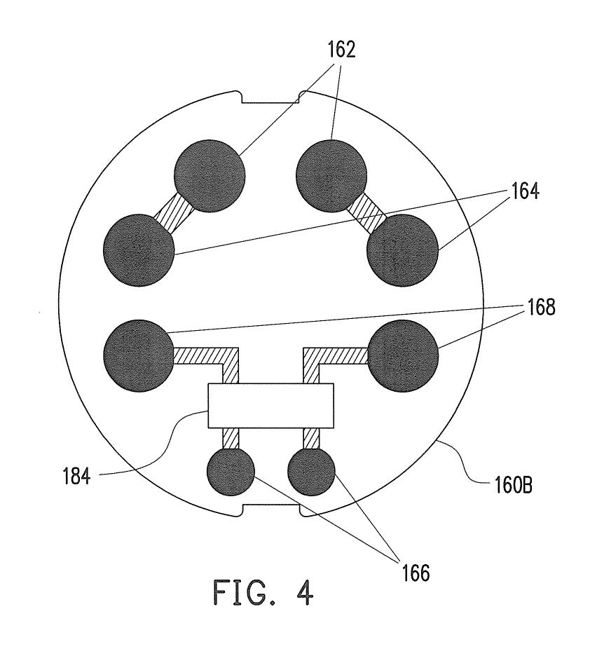

FIG. 4 is a front view of the circuit board of the speaker of FIG. 1 according to another embodiment of the invention. Referring to FIG. 2 and FIG. 4, a difference between the circuit board 160B of the present embodiment and the circuit board 160A of FIG. 2 is that the power controller 184 is disposed on the circuit board 160B. Referring to FIG. 3 and FIG. 4, the electromagnetic inductor 140 can be electrically connected between the power input terminals 166 and the power output terminals 168 of the circuit board 160B, and the power output terminals 168 are electrically connected to the rechargeable battery 182.

Referring to FIG. 3, when the power controller 184 of the present embodiment is used for charging the rechargeable battery 182, the power controller 184 may includes a rectifier 184A and a battery charging chip 184B. The electromagnetic inductor 140 is electrically connected to the rectifier 184A, the rectifier 184A is electrically connected to the battery charging chip 184B, and the battery charging chip 184B is electrically connected to the rechargeable battery 182. Presently, the rechargeable battery 182 in the market has a relatively complicated specification for a charging procedure, so that the battery charging chip 184B is used to control the charging procedure to ideally charge the rechargeable battery 182. For example, the battery charging chip 184 controls to charge the rechargeable battery 182 through a constant current approach in a primary stage of charging. After an output voltage of the rechargeable battery 182 stably reaches a predetermined value, the battery charging chip 184B controls to continually charge the rechargeable battery 182 through a constant voltage approach.

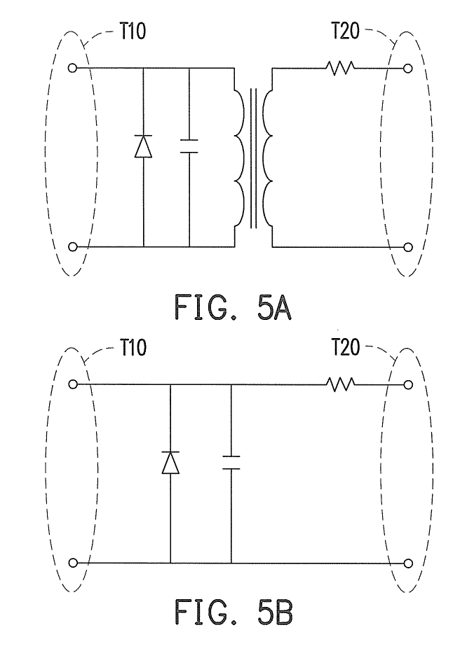

FIG. 5A and FIG. 5B are circuit diagrams illustrating two implementations of the rectifier of the power controller of FIG. 3. The rectifier 184A of the power controller 184 can be implemented by a circuit structure shown in FIG. 5A or FIG. 5B. Referring to FIG. 4, FIG. 5A and FIG. 5B, input terminals T10 of the rectifier 184A can be electrically connected to the power input terminals 166 of the circuit board 160B, and output terminals T20 can be electrically connected to the power output terminals 168. Alternatively, referring to FIG. 2, FIG. 5A and FIG. 5B, the input terminals T10 of the rectifier 184A can be electrically connected to the power output terminals 168 of the circuit board 160B, or the output terminals T20 of the rectifier 184A can be electrically connected to the power input terminals 166.

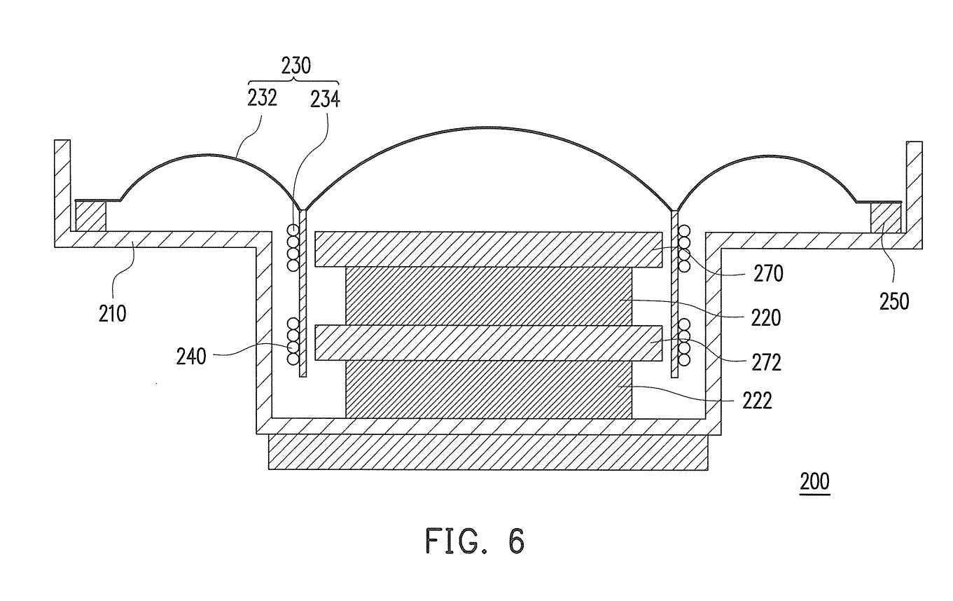

FIG. 6 is a cross-sectional view of a speaker according to another embodiment of the invention. Referring to FIG. 6, the speaker 200 of the present embodiment is similar to the speaker 100 of the previous embodiment, and differences there between are introduced below. The speaker 200 further includes a diaphragm ring 250, a magnet 222 and a yoke 272. The diaphragm ring 250 is disposed in a housing 210, and a diaphragm 232 is disposed on the diaphragm ring 250. The magnet 222, the yoke 272, a magnet 220 and a yoke 270 are stacked in the housing 210. A coil 234 of a vibrating element 230 is located next to the magnet 220 and the yoke 270, and a magnetic field of the coil 234 interacts with a magnetic field of the magnet 220 to drive the diaphragm 232 to vibrate for sounding. A electromagnetic inductor 240 is located next to the magnet 222 and the yoke 272 for inducting a magnetic field of the magnet 222 to generate electricity.

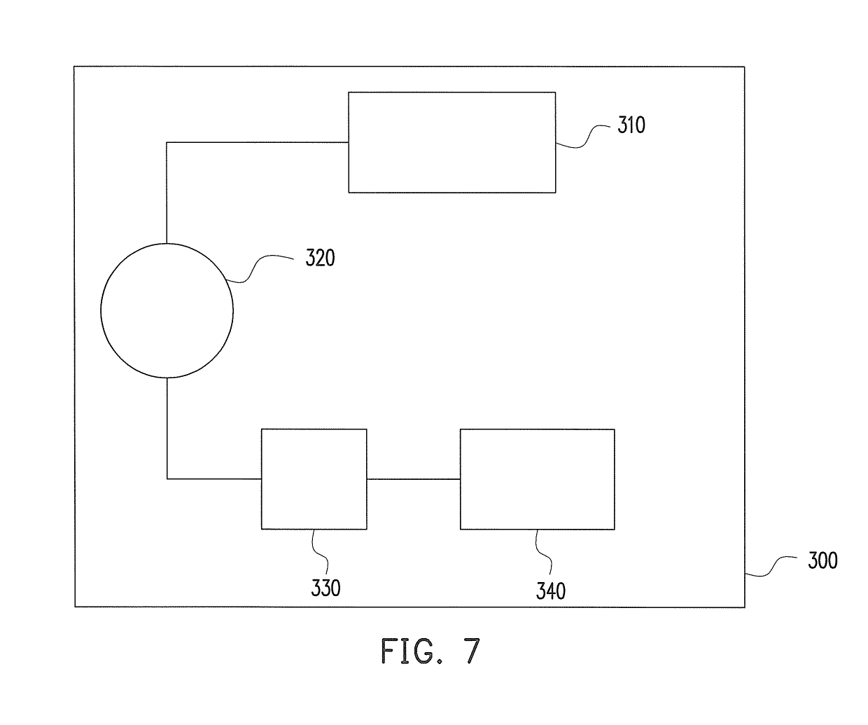

FIG. 7 is a circuit block diagram illustrating an electronic device according to an embodiment of the invention. Referring to FIG. 7, the electronic device 300 of the present embodiment includes an audio generator 310 and a speaker 320. The speaker 320 can be the speaker 100 of FIG. 1, the speaker 200 of FIG. 6 or other speakers within the scope of the invention. Namely, the speaker 320 also has a electromagnetic inductor (not shown) for producing electricity. A detailed structure of the speaker 320 is as that described in the above embodiments, and descriptions thereof are not repeated. The audio generator 310 is electrically connected to audio input terminals (for example, the audio input terminals 164 of FIG. 2) of the speaker 320. The electronic device 300 of the present embodiment can be a mobile phone, a walkie-talkie, a wireless earphone or other electronic devices. The electronic device 300 of the present embodiment may further include a power controller 330 and a rechargeable battery 340. The power controller 330 can be independent to the speaker 320, or can also be built within the speaker 320. The electricity generated by the electromagnetic inductor of the speaker 320 can be provided to the rechargeable battery 340 through the power controller 330, though the electricity generated by the electromagnetic inductor of the speaker 320 can also be directly provided to the rechargeable battery 340. A detailed structure of the power controller 330 is the same as the power controller 184 of FIG. 3.

In summary, the speaker of the invention has the electromagnetic inductor capable of inducting the magnetic field of the magnet to generate electricity. Therefore, the speaker of the invention can use the electricity generated by the electromagnetic inductor to execute additional functions, so as to meet a current environmental trend of carbon reduction. The electronic device of the invention applies the speaker having the electromagnetic inductor capable of generating electricity. Therefore, the electronic device of the invention can also use the electricity generated by the electromagnetic inductor to execute additional functions, so as to meet the current environmental trend of carbon reduction.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A speaker, comprising:
a housing;
a magnet, disposed in the housing;
a vibrating element, disposed in the housing to vibrate relative to the magnet for sounding;
a electromagnetic inductor, disposed on the vibrating element, for inducting a magnetic field of the magnet to generate electricity; and
a circuit board, disposed at the housing, and having two audio input terminals, two audio output terminals, two power input terminals and two power output terminals, wherein the audio input terminals are electrically connected to the audio output terminals, respectively, the power input terminals are electrically connected to the power output terminals, respectively, the vibrating element is electrically connected to the audio output terminals, and the electromagnetic inductor is electrically connected to the power input terminals.

2. The speaker as claimed in claim 1, wherein the vibrating element comprises a diaphragm and a coil disposed on the diaphragm.

3. The speaker as claimed in claim 2, wherein the coil is electrically connected to the audio output terminals.

4. The speaker as claimed in claim 1, further comprising a power controller electrically connected to the electromagnetic inductor.

5. The speaker as claimed in claim 4, further comprising a rechargeable battery electrically connected to the electromagnetic inductor through the power controller for storing electricity generated by the electromagnetic inductor.

6. The speaker as claimed in claim 5, wherein the power controller is electrically connected to the power input terminals, and the power output terminals are electrically connected to the rechargeable battery.

7. The speaker as claimed in claim 5, wherein the power controller comprises a rectifier and a battery charging chip, the electromagnetic inductor is electrically connected to the rectifier, the rectifier is electrically connected to the battery charging chip, and the battery charging chip is electrically connected to the rechargeable battery.

8. The speaker as claimed in claim 4, wherein the power controller is disposed on the circuit board, and the power input terminals are electrically connected to the power output terminals through the power controller.

9. An electronic device, comprising:
an audio generator; and
a speaker, comprising:
a housing;
a magnet, disposed in the housing;
a vibrating element, disposed in the housing to vibrate relative to the magnet for sounding;
a electromagnetic inductor, disposed on the vibrating element, for inducting a magnetic field of the magnet to generate electricity; and
a circuit board, disposed at the housing, and having two audio input terminals, two audio output terminals, two power input terminals and two power output terminals, wherein the audio input terminals are electrically connected to the audio output terminals, respectively, the power input terminals are electrically connected to the power output terminals, respectively, the vibrating element is electrically connected to the audio output terminals, the electromagnetic inductor is electrically connected to the power input terminals, and the audio generator is electrically connected to the audio input terminals.

10. The electronic device as claimed in claim 9, wherein the vibrating element comprises a diaphragm and a coil disposed on the diaphragm.

11. The electronic device as claimed in claim 10, wherein the coil is electrically connected to the audio output terminals.

12. The electronic device as claimed in claim 9, further comprising a power controller electrically connected to the electromagnetic inductor.

13. The electronic device as claimed in claim 12, further comprising a rechargeable battery electrically connected to the electromagnetic inductor through the power controller for storing electricity generated by the electromagnetic inductor.

14. The electronic device as claimed in claim 13, wherein the power controller is electrically connected to the power output terminals.

15. The electronic device as claimed in claim 13, wherein the power controller comprises a rectifier and a battery charging chip, the electromagnetic inductor is electrically connected to the rectifier, the rectifier is electrically connected to the battery charging chip, and the battery charging chip is electrically connected to the rechargeable battery.

16. The electronic device as claimed in claim 12, wherein the power controller is disposed on the circuit board, and the power input terminals are electrically connected to the power output terminals through the power controller.
